(19) United States
(12) Patent Application Publication
(10) Pub. No.: US 2002/0161991 A1
(43) Pub. Date: Oct. 31, 2002

(54) Method of forming collateral alliance between Windows 9X system and Windows NT 4.0 system

(76) Inventors: Yong-Jun Shi, Tienchin (CN); Tong S. Chen, Taipei (TW); Kuang Shin Lin, Taipei (TW)

Correspondence Address: J.C. Patents, Inc., 4 Venture, Suite 250, Irvine, CA, 92618, US

(21) Appl. No.: 09/761,879

(22) Filed: Jan. 17, 2001

(51) Int. Cl. G06F 15/177; G06F 9/24; G06F 9/00

(52) U.S. Cl. 713/1

(57) ABSTRACT

A method of forming a collateral alliance between Windows 9X system and Windows NT 4.0 system suitable for writing the image data of a seed hard drive to a target hard drive. The method includes writing image data into the target hard drive and then finding a boot file that registers the hard drive parameters in the target hard drive. An error signal is issued and the transaction is terminated when the boot file is not found. If the boot file is found, hard drive parameters of the hard drive is retrieved and written into the boot file.

### BACKGROUND OF THE INVENTION

1. Field of Invention

The present invention relates to a method of forming a collateral alliance between two different systems. More particularly, the present invention relates to a method of forming a collateral alliance between Windows 9X system and Windows NT 4.0 system.

2. Description of Related Art

Most personal computer (PC) or notebook manufacturers are required to install an operating system (OS) inside their product. In general, a hard drive with all the necessary operation system will serve a seed hard drive. Data within the seed hard drive is next converted into image data and then directly written into the hard drive within the personal computer or notebook computer. Using the aforementioned method, the data in the hard drive of each computer on the product line will be identical to the data in the seed hard drive. However, different computers may use different types of hard drive. Hence, size of partitions and their assignments inside the hard drive may differ much from the seed hard drive. Although the seed hard drive may contain both Windows 9X system and Windows NT 4.0 system, the Windows 9X system may not be activated after transferring the image data to the computer hard drive. This is because the hard drive differs in internal configuration from the seed hard drive.

To deal with the problem, two methods are often employed. The first method is to install either the Windows 9X system or the Windows NT 4.0 system but not both. However, this may not meet the demands of users. Another method is to demand all computer requiring both the Windows 9X system and the Windows NT 4.0 system to use a type of hard drive having a configuration identical to the seed hard drive. Although the methods may meet the demands of users, the types of hard drives are restricted. Moreover, image data corresponding to the image data inside the seed hard drive must be supplied to each hard drive.

### SUMMARY OF THE INVENTION

Accordingly, one object of the present invention is to provide a method of forming a collateral alliance between the Windows 9X system and the Windows NT 4.0 system suitable for writing image data from a seed hard drive to a target hard drive. The method includes writing image data into the target hard drive and then searching the target hard drive for a boot file (such as bootsec.dos in a Windows NT 4.0 system) capable of recording the hard drive parameters. If the boot file does not exist, an error indication is signaled and the transaction is terminated. If the boot file is found, the hard drive parameters of the target hard drive is written into the boot file.

This invention also provides a method of forming a collateral alliance between the Windows 9X system and the Windows NT 4.0 system suitable for writing image data from a seed hard drive to a target hard drive. The method includes capturing the hard drive serial number of a target hard drive and determining validity of the number. If the hard drive serial number is invalid, the transaction is terminated. On the other hand, if the hard drive serial number is valid, hard drive parameters of the target hard drive is retrieved. Thereafter, image data is copied to the target hard drive. The boot section of the target hard drive is searched to look for a boot file. If the boot file does not exist, an error signal is issued and the transaction is terminated. If the boot file is found, the hard drive parameters are written into the boot file.

This invention modifies the reference boot file in the target hard drive and uses the hard drive parameters of the target hard drive to replace the hard drive parameters in the seed hard drive. Hence, the Windows 9X system of the Windows 9X/NT 4.0 dual system within the target hard drive can still be activated in spite of having hard parameters that differ from the seed hard drive. In addition, other parameters and software within the target hard drive are unaffected, and furthermore the method can be used under disk operating system (DOS) to speed operation.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart showing the steps for forming a collateral alliance between Windows 9X system and Windows NT 4.0 system according to a first preferred embodiment of this invention;

FIG. 2 is a block diagram showing the results after executing the steps according to the first embodiment of this invention; and

FIG. 3 is a flow chart showing the steps for forming a collateral alliance between Windows 9X system and Windows NT 4.0 system according to a second preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

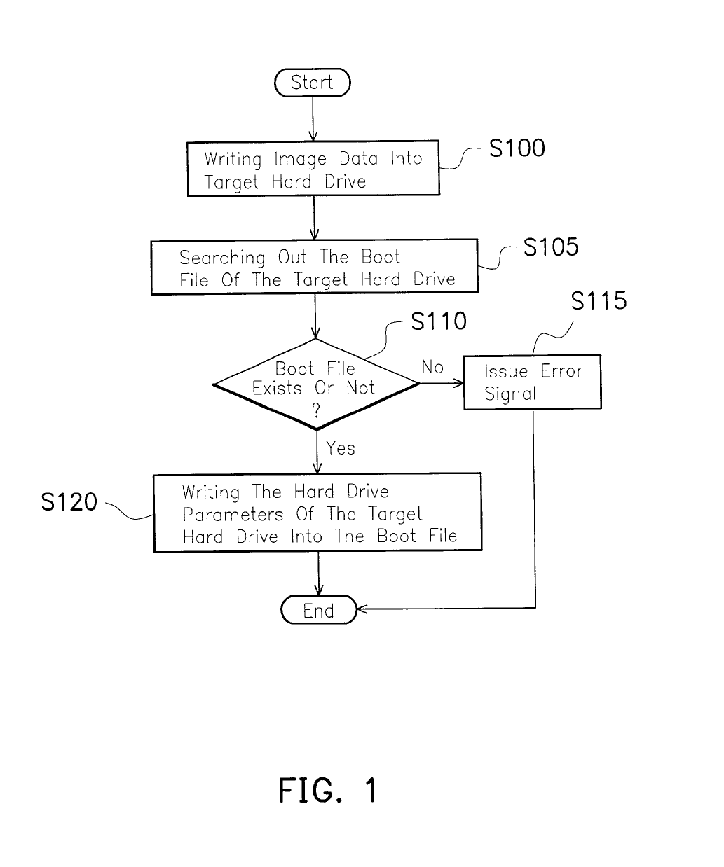

FIG. 1 is a flow chart showing the steps for forming a collateral alliance between Windows 9X system and Windows NT 4.0 system according to a first preferred embodiment of this invention. In step S100, image data retrieved from a seed hard drive is written to a target hard drive. In step S105, the target hard drive is searched to find a boot file. In a Windows NT system, the boot file is a system file placed in a boot section called Bootsect.dos. Thereafter, in step S110, the target hard drive is checked to determine if the boot file exists. When the boot file does not exist in the boot section, an error signal is issued to inform the user in step S115. If the boot file does exist, hard disk parameters of the target hard drive are written into the boot file in step S120.

Note that retrieval of the hard drive parameters from the target hard drive can be carried out at any time before writing the parameters into the boot file. There is no restriction on the retrieval to a particular period.

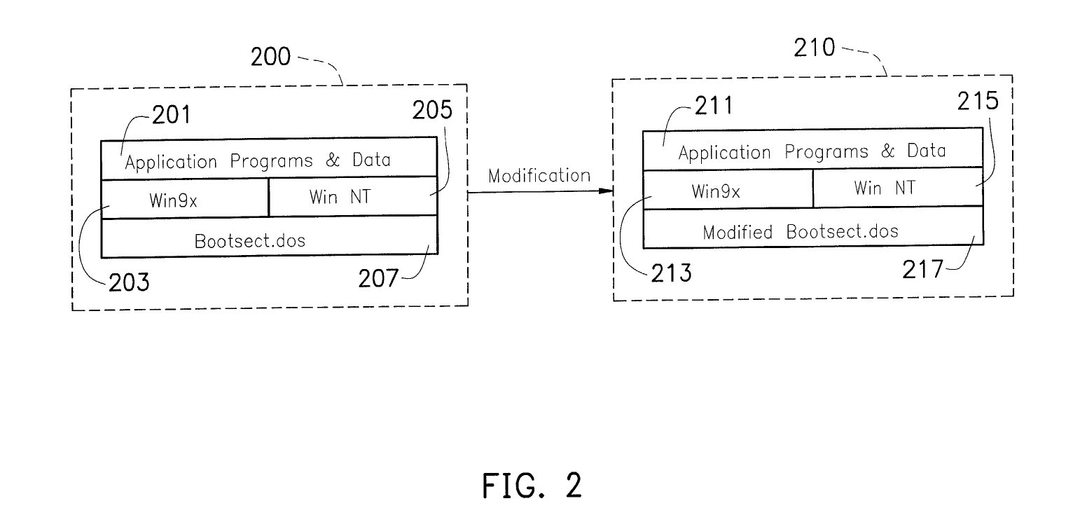

FIG. 2 is a block diagram showing the results after executing the steps according to the first embodiment of this invention. As shown in FIG. 2, image data 200 includes application programs and data 201, a Windows 9X system 203, a Windows NT system 205 and a Bootsect.dos file 207 or the aforementioned boot file for holding the hard disk parameters of a seed hard drive. After the image data 200 is copied to the target hard drive, contents within the application programs and data 205, the Windows 9X system 203 and the Windows NT system 205 will remain unchanged and become the application programs and data 210, the Windows 9X system 213 and the Windows NT system 215 of the target hard drive. On the other hand, the seed hard drive parameters in the Bootsect.dos file 207 of the image data 200 is replaced by the target hard drive parameters in the Bootsect.dos file 217 of the image data 210.

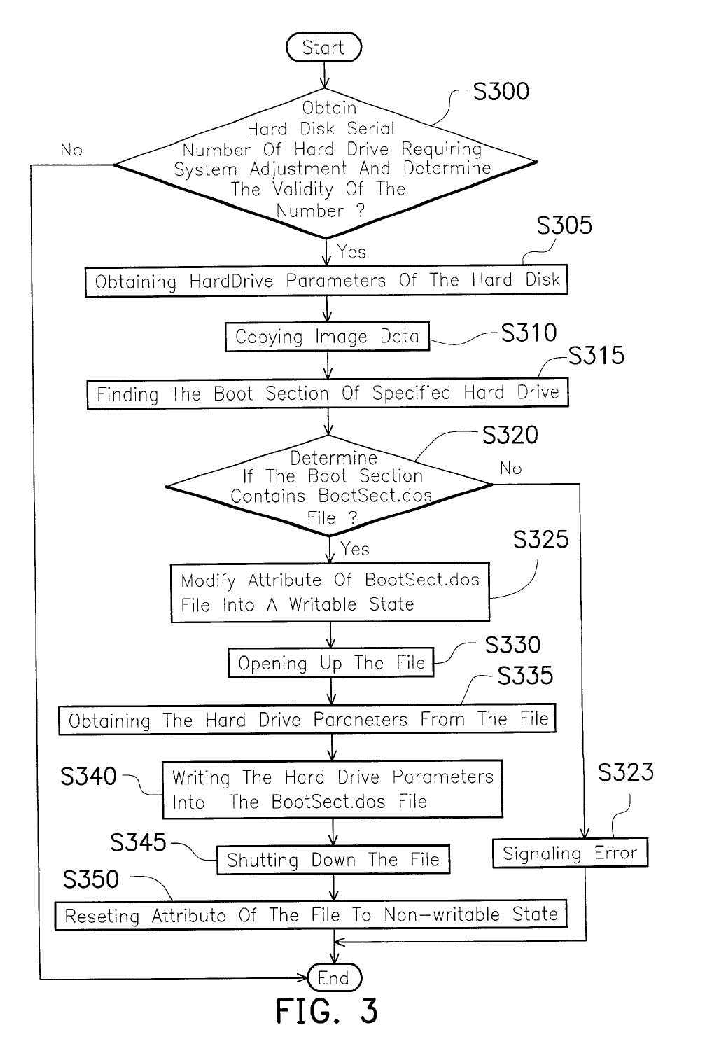

FIG. 3 is a flow chart showing the steps for forming a collateral alliance between Windows 9X system and Windows NT 4.0 system according to a second preferred embodiment of this invention. In step S300, hard drive serial number of the target hard drive necessary for performing system adjustment is retrieved. A judgement is made regarding validity of the hard drive serial number. If the hard drive serial number is invalid, the transaction is terminated. When the hard drive serial number is genuine, the following steps are carried out. In step S305, hard drive parameters of the target hard drive are captured. Note that the retrieval of the hard drive parameters from the target hard drive can be carried out at any time before the modification of the boot file, and hence not restricted to a particular period. Image data is copied in step S310. After image data copying is finished, boot section within the specified hard drive or target hard drive is searched in step S315. In step S320, the boot section is searched to determine if a boot file, Bootsect.dos in Windows NT, exists or not. If the boot file does not exist, an error signal is issued in step S323 and the transaction is terminated. If the boot file does exist, the next step S325 is executed.

In step S325, the boot file (since Windows NT is used in the embodiment, Bootsect.dos replaces the common term boot file thereafter) is set to a writable state. In the writable state, hard drive parameters within the Bootsec.dos are retrieved in step S335. In step S340, hard drive parameters of the target hard drive are written into the Bootsect.dos file. After the writing of hard drive parameters is completed, a boot file is shut down in step S345 and then returned to the original state in step S350. Since the Bootsect.dos file of the Windows NT system is originally in the non-writable state, the boot file is set to a non-writable state in this embodiment.

In conclusion, this invention uses the hard drive parameters of the target hard drive to replace the hard drive parameters in the seed hard drive. Hence, the Windows 9X system of the Windows 9X/NT 4.0 dual system within the target hard drive can still be activated in spite of having hard parameters that differ from the seed hard drive. In addition, other parameters and software within the target hard drive are unaffected and that the method can be used under disk operating system (DOS) to speed operation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of forming a collateral alliance between Windows 9X system and Windows NT 4.0 system suitable for writing the image data of a seed hard drive to a target hard drive, comprising the steps of:
writing the image data into the target hard drive;
finding a boot file in the target hard drive, wherein the boot file records a hard drive parameter;
issuing an error signal and terminating the transaction when the boot file is not found;
finding hard drive parameters of the hard drive; and
writing the hard drive parameters of the target hard drive into the boot file.

2. The method of claim 1, wherein the step of finding a boot file includes searching the boot section of the target hard drive.

3. The method of claim 1, wherein the method further includes the steps of:
setting the boot file from an original state to a writable state when the boot file is found; and
resetting the boot file back to the original state after the hard drive parameters of the target hard drive are written to the boot file.

4. A method of forming a collateral alliance between Windows 9X system and Windows NT 4.0 system suitable for writing the image data of a seed hard drive to a target hard drive, comprising the steps of:
retrieving a hard drive serial number from the target hard drive and determining validity of the serial number;
terminating the transaction if the hard drive serial number is invalid;
retrieving hard drive parameters of the target hard drive when the hard drive serial number is valid;
copying the image data to the target hard drive;
finding a boot file in the boot section of the target hard drive;
issuing an error signal and terminating the transaction when the boot file is not found; and
writing the hard drive parameters into the boot file when the boot file is found.

5. The method of claim 4, wherein the method further includes the following steps:
setting the boot file from an original state to a writable state when the boot file is found; and
resetting the boot file back to the original state after writing the hard drive parameters of the target hard drive into the boot file.
